(19) United States
(12) Patent Application Publication
(10) Pub. No.: US 2024/0178693 A1
(43) Pub. Date: May 30, 2024

(54) SYSTEM FOR CONTROLLING CHARGING OF A BATTERY

(71) Applicant: Cirrus Logic International Semiconductor Ltd., Edinburgh (GB)

(72) Inventors: Jeffrey D. ALDERSON, Austin, TX (US); Jon D. HENDRIX, Austin, TX (US); John L. MELANSON, Austin, TX (US)

(73) Assignee: Cirrus Logic International Semiconductor Ltd., Edinburgh (GB)

(21) Appl. No.: 18/458,490

(22) Filed: Aug. 30, 2023

Related U.S. Application Data
(60) Provisional application No. 63/428,950, filed on Nov. 30, 2022.

(51) Int. Cl. H02J 7/00; H01M 10/48; H01M 10/615; H01M 10/623; H01M 10/63; H01M 10/6571; H05B 6/06

(52) U.S. Cl. CPC H02J 7/00712; H01M 10/48; H01M 10/615; H01M 10/623; H01M 10/63; H01M 10/6571; H02J 7/0048; H02J 7/005; H02J 7/0068; H05B 6/06; H01M 2220/30

(57) ABSTRACT

A system for controlling charging of a battery, the system comprising: charging circuitry for supplying a charging current or voltage to the battery, wherein the charging circuitry is configured to periodically detect an impedance of the battery and to control the charging current or voltage based on the detected impedance.

### FIELD OF THE INVENTION

The present disclosure relates to a system for controlling charging of a battery.

### BACKGROUND

Portable electronic devices such as mobile telephones, tablet and laptop computers, portable media players, virtual reality (VR) or augmented reality (AR) headsets, portable gaming devices and the like are typically powered by a rechargeable battery.

The charging performance of a battery, for example a charging speed (e.g. a time required to reach a given level of charge with a given charging current) or a charging efficiency, can vary according to the temperature of the battery. For some battery chemistries, the charging performance may be improved or optimised if the battery is maintained within a predetermined temperature range during charging.

### SUMMARY

According to a first aspect, the invention provides a system for controlling charging of a battery, the system comprising: charging circuitry for supplying a charging current or voltage to the battery, wherein the charging circuitry is configured to periodically detect an impedance of the battery and to control the charging current or voltage based on the detected impedance.

The system may further comprise a heating arrangement for heating the battery. The charging circuitry may be configured to control the heating arrangement based on the detected impedance of the battery to maintain a temperature of the battery within a predefined range for charging.

The charging circuitry may be configured to detect a voltage and a current of the battery and to detect the impedance based on the detected voltage and current.

The charging circuitry may be configured to infer a temperature of the battery based on the detected impedance.

The system may further comprise a heating arrangement for heating the battery. The charging circuitry may be configured to control the heating arrangement based on the inferred temperature of the battery.

The charging circuitry may be configured to control the heating arrangement based on the inferred temperature of the battery and one of more of: a state of charge (SoC) of the battery; and a state of health (SoH) of the battery.

The charging circuitry may be configured to control the charging current supplied to the battery based on the inferred temperature of the battery.

The charging circuitry may be configured to control the charging current supplied to the battery based on the inferred temperature of the battery and one or more of: a state of charge (SoC) of the battery; and a state of health (SoH) of the battery.

The charging circuitry may be configured to detect the impedance of the battery across a plurality of different frequencies or frequency ranges, and to infer the temperature of the battery based on the detected impedance across the plurality of different frequencies or frequency ranges.

The charging circuitry may be configured to monitor a load current drawn from the battery and to detect the impedance of the battery across the plurality of different frequencies or frequency ranges based on the monitored load current to generate an electrochemical impedance spectrum (EIS) measurement output for the battery.

The charging circuitry may be configured to control a current consuming device to draw additional current from the battery if the frequency content of the monitored load current is insufficient to detect the impedance of the battery across a minimum number of different frequencies or frequency ranges.

The charging circuitry may be configured to determine a quality metric for the load current based on a spectral content and amplitude of the load current, and to control the current consuming device to draw the additional current from the battery if the quality metric is below a predefined threshold.

The charging circuitry may be configured to compare the EIS measurement output generated by the charging circuitry for the battery to a set of reference EIS measurement outputs to infer the temperature of the battery.

The system may be configured to: receive a temperature measurement of a host device incorporating the system when the host device is inactive or in a sleep or idle mode of operation; detect the impedance of the battery when the host device is inactive or in the sleep or idle mode of operation; and calibrate the system using the received temperature measurement and the detected impedance when the host device is inactive or in the sleep or idle mode of operation.

The heating arrangement may comprise a coil for inductive power transfer between a host device incorporating the system and another device.

The heating arrangement may comprise an array of resistive elements disposed, in use of the system, in proximity to the battery.

The heating arrangement may comprise circuitry configured to supply a signal or waveform to the battery to cause a change in a temperature of the battery by changing resistive losses in the battery.

The circuitry may be configured to supply a time varying current or voltage signal to the battery.

The charging circuitry may be operable, when the system is connected to a power source external to the system, to: detect the impedance of the battery; determine a temperature of the battery based on the detected impedance; and if the determined temperature of the battery is below a predetermined battery temperature range, output a heating control signal to cause the heating arrangement to heat the battery.

The charging circuitry may be further operable to delay charging of the battery until the temperature of the battery has reached the predetermined battery temperature range.

According to a second aspect, the invention provides a system for controlling charging of a battery, the system comprising: a charging circuit configured to: detect an impedance of the battery; infer, based on the detected impedance of the battery, a temperature of the battery; and supply a charging current to the battery, wherein the charging current is based on the inferred temperature of the battery.

According to a third aspect, the invention provides a system for controlling charging of a battery, the system comprising: a heating arrangement for heating the battery; a charging circuit configured to detect a temperature of the battery and to control the heating arrangement based on the detected temperature to maintain an impedance of the battery within a predefined impedance range for charging.

According to a fourth aspect, the invention provides a system for estimating a temperature of a battery, wherein the system is configured to: monitor a load current drawn from the battery; based on the monitored load current, detect the impedance of the battery across a plurality of different frequencies or frequency ranges to generate an electrochemical impedance spectrum (EIS) measurement output for the battery; and estimate the temperature of the battery based on the EIS measurement output.

The system may be further configured to receive a battery state of charge (SoC) and/or state of health (SoH) and to estimate the temperature of the battery based on a combination of the EIS measurement output and the SoC and/or SoH.

The system may be configured to compare the EIS measurement output to a set of reference EIS measurement outputs to infer the temperature of the battery.

The system may be further configured to: receive a battery state of charge (SoC) and/or state of health (SoH); select at least one reference EIS measurement output based on the received SoC and/or SoH; and estimate the temperature of the battery based on the selected at least one reference EIS measurement output and the EIS measurement output generated by the system.

The system may be configured to control a current consuming device to draw additional current from the battery if a frequency content of the monitored load current is insufficient to detect the impedance of the battery across a minimum number of different frequencies or frequency ranges.

The system may be configured to determine a quality metric for the load current based on the spectral content and amplitude of the load current, and to control the current consuming device to draw the additional current from the battery if the quality metric is below a predefined threshold.

The system may be configured to: receive a temperature measurement of a host device incorporating the system when the host device is inactive or in a sleep or idle mode of operation; detect the impedance of the battery when the host device is inactive or in the sleep or idle mode of operation; and calibrate the system using the received temperature measurement and the detected impedance when the host device is inactive or in the sleep or idle mode of operation.

According to a fifth aspect, the invention provides a system for controlling charging of a battery, the system comprising: charging circuitry for supplying a charging current to the battery; and a heating arrangement for heating the battery, wherein the charging circuitry is configured to detect an impedance of the battery and to control the heating arrangement based on the detected impedance to maintain a temperature of the battery within a predefined temperature range for charging.

According to a sixth aspect, the invention provides an integrated circuit comprising a system according to any of the first to fifth aspects.

According to a seventh aspect, the invention provides a host device comprising a system according to any of the first to fifth aspects.

The host device may comprise a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a battery powered electronic device having a charging system according to the present disclosure for charging a battery of the device;

FIG. 2 is a schematic representation of a battery powered electronic device having an alternative charging system according to the present disclosure for charging a battery of the device;

FIGS. 3a-3d are plots showing example electrochemical impedance spectroscopy (EIS) measurement outputs for a battery at different states of charge; and

FIG. 4 is a schematic representation of a battery powered electronic device having a battery temperature estimation system according to the present disclosure.

### DETAILED DESCRIPTION

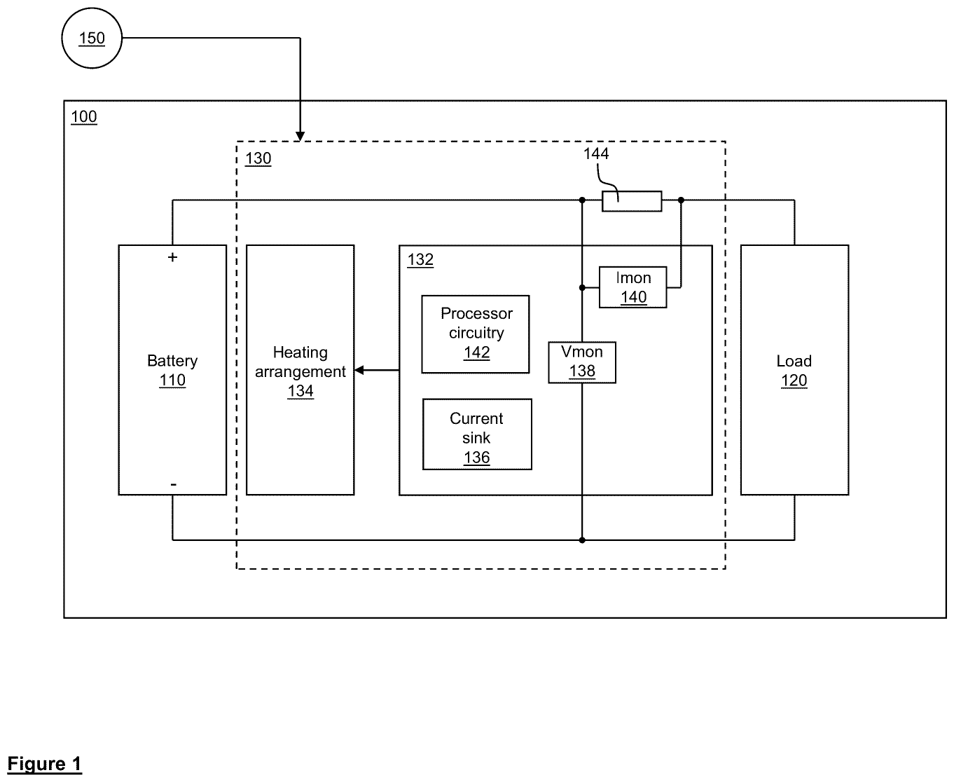

Referring first to FIG. 1, a battery powered electronic device is shown generally at 100. The battery powered electronic device 100 may be, for example, a mobile telephone, a tablet or laptop computer, a portable media player, a virtual reality (VR) or augmented reality (AR) headset, a portable gaming device or the like. The battery powered electronic device includes a battery 110 which supplies electrical power to a load 120. The load 120 may include one or more components or subsystems of the battery powered electronic device 100, e.g. a processing subsystem, a display subsystem, an audio subsystem, a user input subsystem and the like.

The battery powered electronic device 100 further includes a charging system 130 for charging the battery 110. The charging system 130 is configured to receive a supply of power from a power source or charging device 150 such as a mains powered charger external to the battery powered electronic device 100, and to supply a charging current or voltage to the battery 110. The charging system 130 includes charging circuitry 132 and may also include a heating arrangement 134. The charging system 130 may also include, in some examples, a current sink 136. The charging circuitry 132 may be implemented as a standalone IC, or may be implemented in an IC such as a battery fuel gauge IC.

The charging circuitry 132 is configured to supply a charging current or voltage to the battery 110. The charging circuitry 132 is further configured to detect (periodically or continuously) an impedance of the battery 110 and to control the charging current or voltage based on the detected impedance of the battery 110. The charging circuitry 132 may, additionally or alternatively, control the heating arrangement 134 (if provided) based on the detected impedance of the battery 110 to maintain the temperature of the battery within a predefined temperature range, to optimise or at least improve the charging performance of the battery.

In some examples, the charging circuitry 132 is configured to detect a voltage of the battery 110 and a load current being drawn from the battery 110 by the load 120 and to determine or estimate the impedance of the battery 110 based on the detected voltage and current, by dividing the detected voltage by the detected current. To this end, the charging circuitry 132 may include voltage detection circuitry 138 configured to output a signal indicative of the battery voltage, current detection circuitry 140 configured to output a signal indicative of the load current, and processing circuitry 142 configured to determine or estimate the impedance of the battery 110 based on the signals output by the voltage detection circuitry 138 and current detection circuitry 140. The current detection circuitry 140 may be configured to detect a voltage across a current sense resistor 144 in a current path between the battery 110 and the load 120. The current sense resistor 144 may be provided as part of the charging system 130, as shown in FIG. 1, or alternatively may be external to the charging system 130. The charging circuitry 132 may be configured to monitor the battery voltage and load current continuously in real-time, such that the impedance of the battery 110 can be determined or estimated continuously, or may be configured to periodically sample the battery voltage and load current, such that the impedance of the battery 110 can be determined or estimated periodically. In some examples, the charging circuitry 132 may include a “fuel gauge” integrated circuit (IC) configured to measure the battery voltage and current in real time.

The impedance of the battery 110 depends on a number of different factors, including the temperature of the battery 110, a state of charge (SoC) of the battery 110 (which may be defined as a ratio or percentage of the charge remaining in the battery 110 to a maximum charge storage capacity of the battery 110), a state of health (SoH) of the battery 110 (which is a measurement that indicates a level of degradation and remaining capacity of the battery, and may be defined as a ratio or a percentage of the maximum charge that the battery 110 is able to supply at a given time to the rated capacity of the battery 110), and a frequency of the current being drawn from the battery 110.

In some examples, the charging circuitry 132 is configured to infer a temperature of the battery 110 based on the determined impedance of the battery 110, and to supply a heating control signal to the heating arrangement 134 to cause the heating arrangement to 134 to bring the battery 110 within a predetermined battery temperature range for charging the battery 110.

The heating control signal may be based on the inferred temperature of the battery 110. For example, if the inferred temperature of the battery 110 is below a first temperature threshold (which may represent a lower bound or limit of the predetermined battery temperature range for charging the battery), the charging circuitry 132 may output a suitable heating control signal to cause the heating arrangement 134 to increase an amount of heat supplied to the battery 110, thereby increasing the temperature of the battery 110 to within the predetermined battery temperature range. If the inferred temperature of the battery 110 is above a second temperature threshold (which may represent an upper bound or limit of the predetermined battery temperature range for charging the battery), the charging circuitry 132 may output a suitable heating control signal to cause the heating arrangement 134 to reduce the amount of heat supplied to the battery 110 to reduce the temperature of the battery 110 to within the predetermined battery temperature range.

The charging circuitry 132 continues to monitor the impedance of the battery 110 and to infer the temperature of the battery 110 during charging of the battery, and adjusts the heating control signal as necessary to maintain the temperature of the battery 110 within the predetermined battery temperature range. Thus, the detected impedance of the battery 110 is used by the charging circuitry 132 as a feedback variable to control the heating control signal in order to regulate the temperature of the battery 110.

Some battery powered electronic devices may schedule charging of the battery 110 when they are connected to a charging device. For example, when a battery powered electronic device 100 such as a mobile telephone is connected to a charging device 150 (e.g. when a charger is connected to a charging port of the device 100), if the state of charge of the battery 110 is above a minimum charge threshold, a control system of the device may schedule charging to start at some later time. In such cases, the charging circuitry 132 may output a suitable heating control signal to cause the heating arrangement 134 to heat the battery 110 at an appropriate time, so that it is within the predetermined battery temperature range at the scheduled charging start time.

In other examples, when the battery powered electronic device 100 is connected to an external power source or charging device 150, the control system of the device 100 may cause the charging circuitry 132 to detect the impedance of the battery 110 and infer, estimate or otherwise determine the temperature of the battery 110 based on the detected impedance. If the temperature of the battery 110 is below the predetermined battery temperature range, the charging circuitry 132 may output a suitable heating control signal to cause the heating arrangement 134 to heat the battery 110, and charging of the battery 110 may be delayed by the charging circuitry 132 until such time as the temperature of the battery 110 has reached the predetermined battery temperature range.

In such examples, charging of the battery only commences once the battery is at a temperature at which optimised or improved charging is possible.

In still other examples, the control system of the device 100 may cause the charging circuitry 132 to determine the impedance of the battery 110 and infer, estimate or otherwise determine the temperature of the battery 110 based on the detected impedance when the device 100 is connected to a charging device. If the temperature of the battery 110 is below the predetermined battery temperature range the charging circuitry 132 may output a suitable heating control signal to cause the heating arrangement 134 to heat the battery 110, and may also begin charging the battery 110 immediately, such that charging of the battery 110 initially occurs while the battery 110 is at a sub-optimal temperature for charging, but charging performance improves as the battery temperature reaches the predetermined battery temperature range.

The heating control signal may be, for example, a voltage or a current that is supplied directly to the heating arrangement 134, or may be a switch control signal such as a pulse width modulated (PWM) signal for modulating operation of a switch that controls a voltage or current supply to the heating arrangement 134.

In some examples, in addition to determining or estimating the impedance of the battery 110, the charging circuitry 132 may also be configured to receive information (e.g. a signal) indicative of the battery SoC and/or SoH and/or the frequency of the load current, and/or to estimate, calculate or otherwise determine the battery SoC and/or SoH and/or the frequency of the load current. The charging circuitry 132 may use such additional information in combination with the determined impedance of the battery 110 to infer the temperature of the battery 110. Using such additional information relating to other battery parameters (e.g. SoC, SoH) and/or operational parameters of the electronic device 100 (e.g. the frequency of the load current) may enable the charging circuitry 132 to infer the temperature of the battery 110 more accurately, and may thus permit more accurate control of the temperature of the battery 110 than using the impedance of the battery 110 alone to infer the temperature of the battery 110.

In some examples, in addition to or instead of controlling the temperature of the battery 110 based on the determined impedance of the battery 110, the charging circuitry 132 may also control the charging current supplied to the battery 110 based on the detected impedance of the battery 110, to optimise or improve the charging performance of the battery 110.

In some examples, the charging circuitry 132 may infer the battery temperature based on the determined impedance (and optionally also additional information such as the battery SoC, battery SoH and/or frequency of the load current) and may control the charging current based on the inferred battery temperature to select a charging current that improves or optimises charging of the battery 110 for the inferred battery temperature.

The charging circuitry 132 may determine the charging current to supply to the battery by inputting the inferred battery temperature into a mathematical function, relationship or model linking battery temperature and charging current. Alternatively, the charging circuitry 132 may determine the charging current by selecting an appropriate charging current for the inferred battery temperature from a lookup table containing battery temperature values and corresponding charging current values.

In alternative examples, the charging circuitry 132 may omit to infer the temperature of the battery 110 from the determined battery impedance, and may instead control the heating arrangement 134 based on the determined battery impedance to cause the heating arrangement to 134 to bring the battery 110 within a predetermined battery impedance range for charging the battery 110.

In such examples, the charging circuitry 132 continues to monitor the impedance of the battery 110 during charging of the battery, and adjusts the heating control signal as necessary to maintain the impedance of the battery 110 within the predetermined battery impedance range. Thus, the determined impedance of the battery 110 is used by the charging circuitry 132 as a feedback variable to control the heating control signal in order to regulate the impedance of the battery 110.

In such examples, the charging circuitry 132 may determine the charging current to supply to the battery 110 by inputting the determined battery impedance into a mathematical function, relationship or model linking battery impedance (and optionally other parameters such as battery SoC and/or battery SoH) and charging current.

Alternatively, the charging circuitry 132 may determine the charging current by selecting an appropriate charging current for the determined battery impedance (and optionally other parameters such as battery SoC and/or battery SoH) from a lookup table containing battery impedance values (and optionally other parameters such as battery SoC and/or battery SoH) and corresponding charging current values.

The charging circuitry 132 may be configured to perform a calibration process, either periodically (e.g. every day) or in response to a predetermined calibration trigger condition (e.g. on powering on the device 100, or following a predefined idle period of the device 100) to calibrate a battery temperature inference algorithm that is used by the charging circuitry 132 to infer the temperature of the battery 110 from the detected battery impedance.

When the device 100 is at rest (e.g. when the device is inactive or in a sleep or idle mode of operation), the charging circuitry 132 may receive a signal indicative of a temperature of the device 100, e.g. from an on-board device temperature sensor. As the device is at rest at this time, the temperature of the battery 110 can be assumed to be similar to the temperature of the device 100. The charging circuitry 132 then performs a measurement of the impedance of the battery 110 while the device at rest, e.g. by supplying a known stimulus signal to the battery 110, or by applying a known load to the battery 110 and measuring the battery voltage and current. The measured battery impedance and device temperature can then be used by the charging circuitry 132 as calibration data points to calibrate or recalibrate the battery temperature inference algorithm.

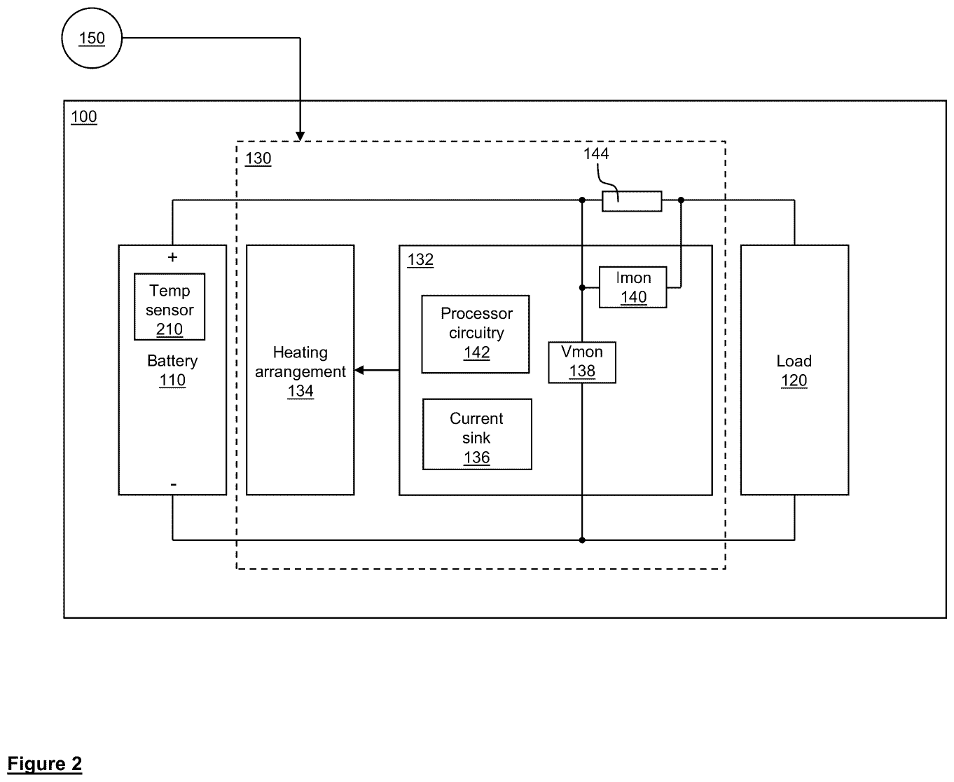

FIG. 2 is a schematic representation of an example representation of a battery powered electronic device including an alternative charging system for charging a battery of the device. Like the battery powered electronic device 100 of FIG. 1, the battery powered electronic device 200 may be, for example, a mobile telephone, a tablet or laptop computer, a portable media player, a virtual reality (VR) or augmented reality (AR) headset, a portable gaming device or the like.

The battery powered electronic device 100 of FIG. 1 and the battery powered electronic device 200 of FIG. 2 have a number of features in common. Such common features are denoted by common reference numerals in FIGS. 1 and 2 and will not be described in detail here for the sake of clarity and brevity.

The battery powered electronic device 200 includes a battery temperature sensing arrangement 210 configured to detect a temperature of the battery 110. The battery temperature sensing arrangement 210 may be a dedicated battery temperature sensing arrangement, and may comprise, for example, a temperature sensing element (e.g. a thermistor, diode, transistor or the like) or an array of temperature sensing elements integral with the battery 110, or disposed on or in the battery 110, or in proximity to the battery 110. The battery temperature sensing arrangement 210 is coupled to the charging circuitry 132, and outputs a signal (e.g. a voltage or current) indicative of a temperature of the battery 110 to the charging circuitry 132.

Alternatively, the battery temperature sensing arrangement 210 may be provided by a component of the device 100 that is used primarily for some other purpose. For example, the battery temperature sensing arrangement 210 could be provided by a coil that is used primarily for inductive power transfer between the device 100 and another device, e.g. a wireless charging device or another battery powered electronic device such as a mobile telephone. A suitable system for sensing and reporting the temperature of the battery 110 using such a coil is described in the applicant's U.S. patent application Ser. No. 18/313,821 filed 8 May 2023, the content of which is incorporated by reference herein in its entirety.

The charging circuitry 132 in the example shown in FIG. 2 thus need not determine the impedance of the battery 110 in order to supply a heating control signal to the heating arrangement 134 to bring the battery 110 within a predetermined battery temperature range for charging the battery 110 or to bring the battery 110 within a predetermined battery impedance range for charging the battery 110.

Instead, the charging circuitry 132 in the example shown in FIG. 2 may supply a heating control signal to the heating arrangement 134 based on the temperature of the battery 110, as detected by the battery temperature sensing arrangement 210, to maintain the battery 110 within the predetermined battery temperature range or the predetermined battery impedance range for charging the battery 110.

The charging circuitry 132 continues to monitor the temperature of the battery 110 (as detected by the battery temperature sensing arrangement 210) during charging of the battery 210, and adjusts the heating control signal as necessary to maintain the temperature of the battery 110 within the predetermined battery temperature range for charging. Thus, the detected temperature of the battery 110 is used by the charging circuitry 132 as a feedback variable to control the heating control signal in order to regulate the temperature or impedance of the battery 110.

The charging circuitry 132 in the example of FIG. 2 may control the charging current supplied to the battery 110 based on the detected battery temperature to select a charging current that improves or optimises charging of the battery 110 for the detected battery temperature.

The charging circuitry 132 may determine the charging current to supply to the battery by inputting the detected battery temperature into a mathematical function, relationship or model linking battery temperature and charging current. Alternatively, the charging circuitry 132 may determine the charging current by selecting an appropriate charging current for the inferred battery temperature from a lookup table containing battery temperature values and corresponding charging current values.

The examples described above with reference to FIGS. 1 and 2 each include a heating arrangement 134. The heating arrangement may comprise a dedicated heating component, e.g. a resistive heating element or an array of resistive elements, disposed (in use of the charging system 130) in proximity to the battery 110 to transfer heat to the battery.

Alternatively, the heating arrangement 134 may be provided by a component of the device 100 that is used primarily for some other purpose. For example, the heating arrangement may be provided by circuitry such as processing circuitry (e.g. a processor integrated circuit) disposed in proximity to the battery 110. When heating of the battery 110 is desired, the processing circuitry can be controlled to perform a redundant function, e.g. calculations whose results are not used for any purpose, to cause the processing circuitry to dissipate heat that is transferred to the battery 110.

As another example, the heating arrangement 134 could be provided by a coil that is used primarily for inductive power transfer between the device 100 and another device, e.g. a wireless charging device or another battery powered electronic device such as a mobile telephone. A suitable system for heating the battery 110 using such a coil is described in the applicant's U.S. patent application Ser. No. 18/313,821 filed 8 May 2023, the content of which is incorporated by reference herein in its entirety.

In a further alternative example, the heating arrangement 134 may comprise circuitry (e.g. waveform generator circuitry) configured to supply a signal or waveform (e.g. a current or voltage signal waveform) to the battery 110 to cause a change (e.g. an increase) in the temperature of the battery 110 by changing (e.g. increasing) resistive losses in the battery.

The signal or waveform may be, for example, a voltage or current having a magnitude that varies (with time) about a centre value between a positive peak magnitude and a negative peak magnitude. In some examples the signal or waveform may be a sinusoidal signal or waveform.

Where the signal or waveform is a variable current, the heat generated by the battery is equal to I²R (where I is an average current magnitude of the variable current signal and R is a resistance of the battery 110), and thus the increasing the magnitude of the variable current signal will increase the heat generated by the battery 110. The variable current signal may vary about a centre value of 0 amps, in which case the magnitude of the variable current signal will vary between +I and −I (where I is the peak current magnitude) or alternatively may vary about some value that is offset from 0 amps, e.g. 1 amp, 2 amps etc, in which case the magnitude of the variable current signal will vary between O+I and O−I (where O is the offset value). Because the heat generated by the battery 110 is proportional to I², a varying current signal that varies about a centre value that is offset from 0 amps will cause the battery to generate more heat than a varying current signal of the same peak magnitude that varies about a centre value of 0 amps.

Similarly, where the signal or waveform is a variable voltage, the heat generated by the battery is equal to V²/R (where V is an average voltage magnitude of the variable voltage signal), and thus increasing the magnitude of the variable voltage signal will increase the heat generated by the battery 110. The variable voltage signal may vary about a centre value of 0 volts, in which case the magnitude of the variable current signal will vary between +V and −V (where V is the peak voltage magnitude) or alternatively may vary about some value that is offset from 0 volts, e.g. 1 volt, 2 volts etc, in which case the magnitude of the variable voltage signal will vary between O+V and O−V (where O is the offset value). Because the heat generated by the battery 110 is proportional to I², a varying voltage signal that varies about a centre value that is offset from 0 volts will cause the battery to generate more heat than a varying voltage signal of the same peak magnitude that varies about a centre value of 0 volts.

In the example described above with reference to FIG. 2, the charging circuitry 132 receives a battery temperature signal from a battery temperature sensor arrangement, and uses this signal to regulate the temperature and/or impedance of the battery 110 within a predefined battery temperature and/or impedance range, and or to control the charging current supplied to the battery 110. In contrast, in the example described above with reference to FIG. 1, the temperature of the battery 110 is inferred, estimated or otherwise determined by the charging circuitry 132 based on the detected impedance of the battery 110.

In some applications, inferring the battery temperature based on a detected, measured or otherwise determined battery impedance facilitates improved battery charging and/or discharging performance, as inferring the temperature may provide a more accurate indication of the temperature of the battery than measuring the battery temperature using a temperature sensing arrangement.

In particular, as part of a general trend to increase capacity and longevity of batteries in portable electronic devices, the physical size of batteries in such devices continues to increase. Accurately and reliably measuring the temperature of such batteries without using a large array of temperature sensors distributed on and/or within the battery can present a significant challenge. It is possible to measure battery temperature using a temperature sensor provided on an IC coupled with the battery, e.g. a battery fuel gauge IC. However, such sensors may be affected by battery charging currents, which may heat up the fuel gauge IC more than the battery itself, leading to inaccurate temperature measurement results.

Further, even if an array of temperature sensors distributed on and/or within the battery is used, accurate measurement of the battery temperature may still be challenging, as localised hot spots may arise in the battery. If any individual temperature sensor of a sensor array is positioned in proximity to such a localised hot spot, the temperature reported by that sensor will reflect the temperature of the hot spot, rather than the lower temperature of the remainder of the battery.

Thus, inferring the battery temperature based on a detected impedance of the battery may be preferable to attempting to measure the battery temperature directly in many applications.

As noted above, it is possible to measure the impedance of a battery in normal operation of a battery powered electronic device (e.g. device 100 or 200) by detecting the voltage and current of the battery. The battery impedance can then be calculated by dividing the detected voltage/current. It is possible to measure battery voltage and current in real time, for example using an IC coupled with the battery, e.g. a battery fuel gauge IC.

The impedance of a battery generally varies with frequency, temperature, SoC and/or SoH. The effect of frequency on battery impedance can be quantified using a technique known as electrochemical impedance spectroscopy (EIS), in which a variable frequency stimulus signal (e.g. a current) is applied to the battery, and the impedance of the battery is determined as the frequency of the stimulus signal changes, to develop a profile of battery impedance vs. frequency. By performing EIS measurements with the battery at different states of charge and/or states of health, a model of the battery's impedance under different conditions can be developed.

It has been found that an EIS measurement at a given SoC and SoH changes by about 7% per degree Celsius. Thus, the present disclosure proposes the use of a dynamic EIS (or EIS-style) measurement of battery impedance, either alone or in combination with additional information such as battery SoC and/or SoC, to infer the temperature of a battery. A charging system 130 including charging circuitry 132 of the kind described above may control a heating arrangement 134 and/or a charging current supplied to a battery 110 by the charging circuitry 132 based on the inferred battery temperature, as described above.

Thus, the charging circuitry 132 (e.g. the processing circuitry 142) may be configured to perform a dynamic EIS (or EIS-style) measurement of the battery 110 to infer the temperature of the battery 110. This EIS (or EIS-style) measurement may be performed in real time, i.e. while the device 100/200 is in operation. The charging circuitry 132 is configured to monitor the load current being drawn from the battery 110 and to use this load current as a substitute for a dedicated EIS stimulus signal supplied to the battery 110. Thus the instantaneous load current being drawn from the battery 110 by the load 120 acts as an effective EIS stimulus signal. This allows the EIS measurement to be performed in real time, instead of requiring a dedicated EIS measurement time in which a dedicated EIS stimulus signal is applied to the battery 110 when it is not under significant load.

The charging circuitry 132 may monitor the load current being drawn from the battery 110 by the load 120 and determine a quality metric based on the spectral content and amplitude of the load current. If the quality metric meets or exceeds a predefined threshold, indicating that the spectral content of the load current is rich enough to perform an EIS measurement (e.g. if the load current has sufficient signal content across a plurality of different frequencies or frequency ranges), the charging circuitry 132 can perform a satisfactory EIS measurement based on the load current. The charging circuitry 132 thus performs an EIS measurement by detecting and recording the impedance of the battery 130 across the plurality of frequencies or frequency ranges present in the load current, to generate an EIS measurement output for the battery 110.

If the quality metric falls below the threshold, this is indicative that the spectral content is not sufficiently rich to perform an EIS measurement. For example, the load current may contain insufficient signal content across a minimum number or range of frequencies or frequency ranges, which may prevent detection of the impedance of the battery across the minimum number or range of frequencies or frequency ranges. In this case, the charging circuitry 132 may defer performing an EIS measurement, as any such measurement may produce inaccurate or unreliable results. Alternatively, the charging circuitry 132 may control the current sink 136 (or another current-consuming device) to cause it to draw additional current from the battery 110, to augment the load current being drawn by the load 120, such that the overall spectral content of the combined current drawn from the battery 110 by the load 120 and the current sink 136 is sufficient to perform an accurate EIS measurement of the battery 110. A description of dynamically monitoring a system load current and augmenting the load current using a controlled current sink is provided in the applicant's U.S. provisional patent application No. 63/415,413 filed 12 Oct. 2022, the content of which is incorporated by reference herein in its entirety.

As noted above, the charging circuitry 132 may be configured to receive or determine the battery SoC and/or SoH. This additional information can be combined with the EIS measurement generated by the charging circuitry 132 based on the load current drawn from the battery 110 by the load 120 (and if necessary the additional current drawn by the current sink 136) to infer or otherwise determine the temperature of the battery.

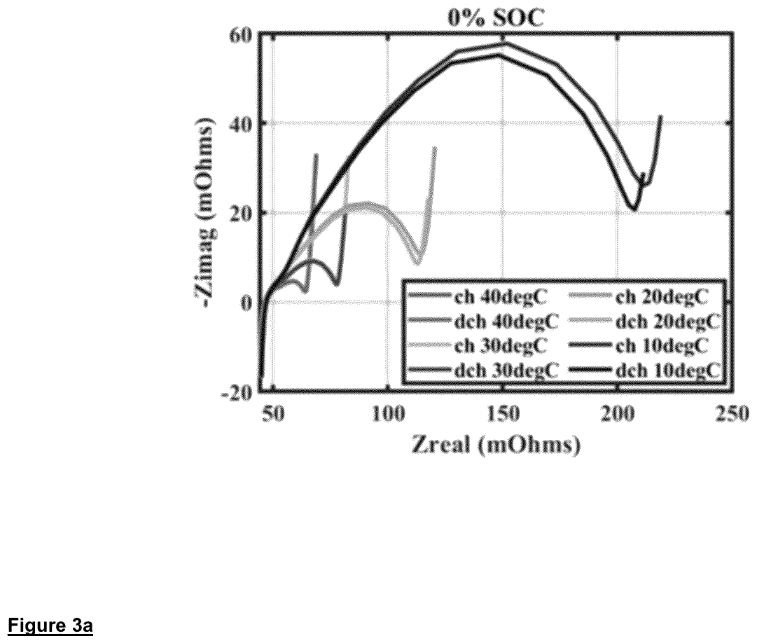

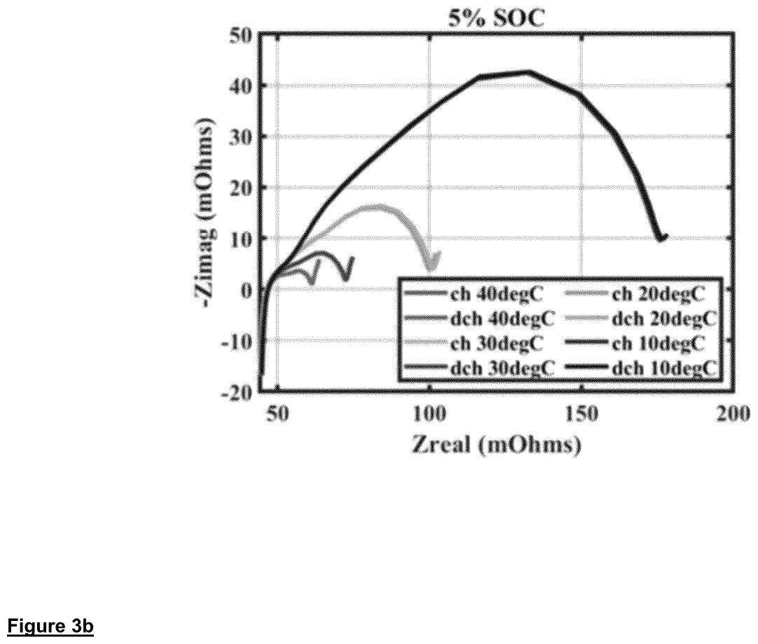

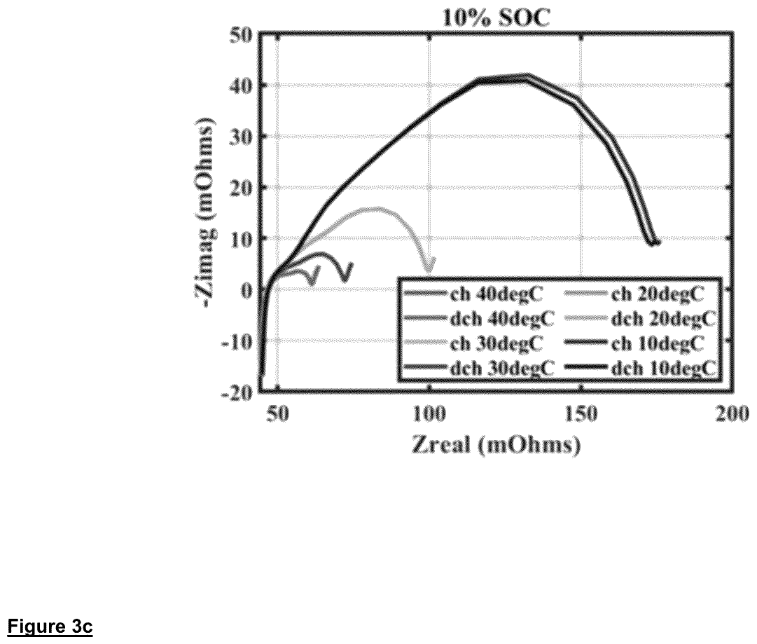

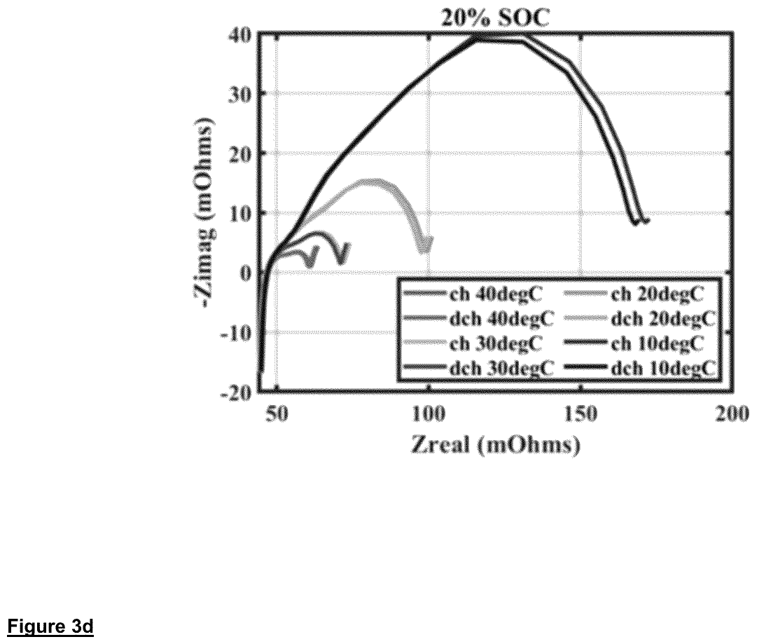

FIGS. 3a-3d are plots showing example EIS measurement outputs for a battery at different states of charge (0%, 5%, 10% and 20% respectively) and at a range of different temperatures. Each EIS measurement output comprises a real part of an impedance of the battery (shown on the x-axis in the plots of FIGS. 3a-3d) and a negative imaginary part of the impedance of the battery (shown on the y-axis in the plots of FIGS. 3a-3d). Each individual trace in the plots of FIGS. 3a-3d represents an EIS measurement output for a different battery temperature and direction of current flow, as indicated by the legend on each plot (where ch represents a flow of current into the battery to charge it and dch represents a flow of current out of the battery, to discharge it). As will be apparent from the EIS measurement plots of FIGS. 3a-3d, the EIS measurement at a given frequency and temperature varies with the battery SoC.

A set of reference EIS measurement outputs for different battery states of charge and temperatures may be stored by the charging system 130 or the device 100/200 (e.g. in a memory of the charging system 130 or in a memory of the device 100/200 that is accessible to the charging system 130). When the charging circuitry 132 has performed an EIS measurement for the battery 110 and has determined or received the battery SoC, the charging circuitry 132 (e.g. the processing circuitry 142) may compare the results of the EIS measurement to the relevant one of the stored reference EIS measurement outputs (i.e. the stored reference EIS measurement output at the battery SoC corresponding to the SoC received or determined by the charging circuitry 132), to determine, estimate or infer the battery temperature, by identifying the reference EIS measurement output that most closely matches or corresponds to the EIS measurement result generated by the charging circuitry 132.

As will be appreciated by those of ordinary skill in the art, it may be useful in a to be able to determine, estimate or infer the temperature of a battery without using an array of discrete sensors in other applications, e.g. to detect potentially damaging or dangerous battery over temperature conditions caused, for example, by excessive battery loading or battery damage. The present disclosure thus extends to a standalone system for determining a battery temperature based on EIS (or EIS-style) measurements.

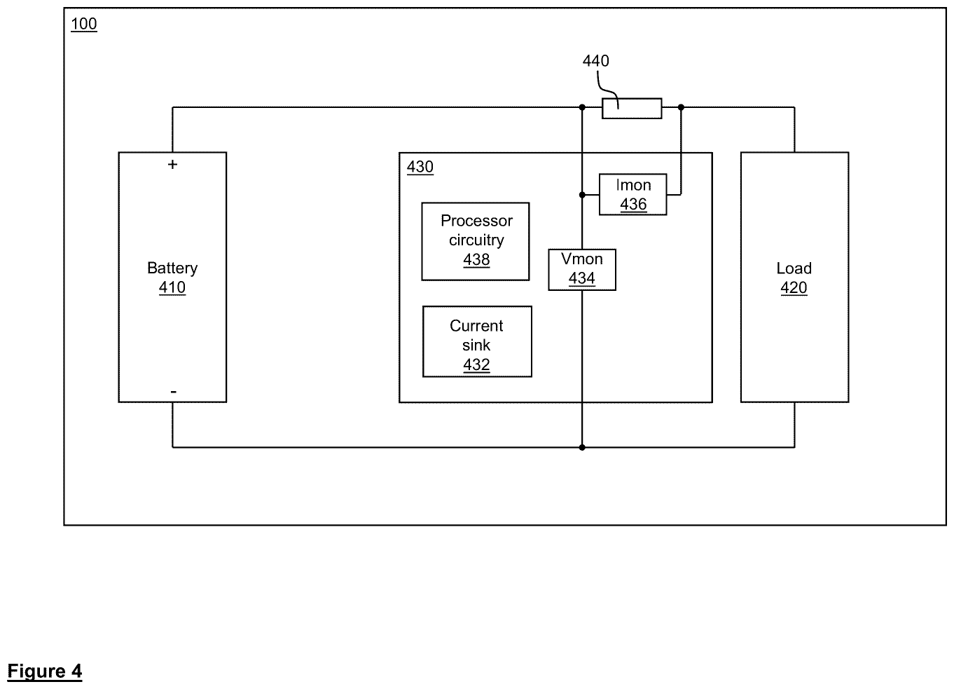

FIG. 4 is a schematic representation of a battery powered electronic device incorporating a system for estimating a battery temperature. The battery powered electronic device 400 may be, for example, a mobile telephone, a tablet or laptop computer, a portable media player, a virtual reality (VR) or augmented reality (AR) headset, a portable gaming device or the like.

The battery powered electronic device 400 includes a battery 410 which supplies electrical power to a load 420, which may include one or more components or subsystems of the battery powered electronic device 400, e.g. a processing subsystem, a display subsystem, an audio subsystem, a user input subsystem and the like.

The battery powered electronic device 400 further includes a temperature estimation system 430, and may also include a current sink 432. The temperature estimation system 430 may be implemented as a single IC, which may also include the current sink 432 (if present). Alternatively, the current sink 432 (if present) may be implemented as a separate IC or in discrete circuitry.

The temperature estimation system 430 is configured to perform a dynamic EIS (or EIS-style) measurement of the battery 410 in real time using a load current drawn from the battery as an effective EIS stimulus signal, as described above with reference to FIGS. 1-3, and to estimate, infer or otherwise determine the temperature of the battery 410 based on the measurement results (and optionally also additional information such as a SoC and/or SoH of the battery 110).

Thus, the temperature estimation system 430 may be include voltage monitoring circuitry 434 configured to monitor a voltage of the battery 410, current monitoring circuitry 436 configured to monitor a load current being drawn from the battery 410 by the load 420, and processing circuitry 438 configured to perform an EIS measurement result based on the monitored current. The current monitoring circuitry 436 may be configured to detect a voltage across a current sense resistor 440 in a current path between the battery 410 and the load 420.

The processing circuitry 438 may be configured to determine a quality metric based on the spectral content and amplitude of the load current. If the quality metric meets or exceeds a predefined threshold, indicating that the spectral content of the load current is rich enough to perform an EIS measurement, e.g. if the load current has sufficient signal content across a plurality of different frequencies or frequency ranges, the temperature estimation system 430 can perform a satisfactory EIS measurement based on the load current.

If the quality metric falls below the predefined threshold, the spectral content is not sufficiently rich to perform an EIS measurement (e.g. the load current contains insufficient signal content across a minimum range of frequencies or frequency ranges, which may prevent detection of the impedance of the battery across the minimum number or range of frequencies or frequency ranges), and the temperature estimation system 430 may defer performing an EIS measurement. Alternatively, the temperature estimation system 430 may control the current sink 432 to cause it to draw additional current from the battery 410 to augment the load current being drawn by the load 420, such that the overall spectral content of the combined current drawn from the battery 410 by the load 420 and the current sink 432 is sufficient to perform an accurate EIS measurement of the battery 410. Again, a description of dynamically monitoring a system load current and augmenting the load current using a controlled current sink is provided in the applicant's U.S. provisional patent application No. 63/415,413 filed 12 Oct. 2022, the content of which is incorporated by reference herein in its entirety.

The temperature estimation system 430 may be configured to receive or determine the battery SoC and/or SoH. This additional information can be combined with the EIS measurement generated by the temperature estimation system 430 based on the load current drawn from the battery 410 by the load 420 (and if necessary the additional current drawn by the current sink 432) to infer or otherwise determine the temperature of the battery 410.

The temperature estimation system 430 may store a set of reference EIS measurement outputs for different battery states of charge and/or states of health and temperatures.

When the temperature estimation system 430 has performed an EIS measurement for the battery 410 and has determined or received the battery SoC and/or SoH, the temperature estimation system 430 may compare the results of the EIS measurement to the relevant one of the stored reference EIS measurement outputs (i.e. the stored reference EIS measurement output at the battery SoC and/or SoH corresponding to the SoC and/or SoH received or determined by the temperature estimation system 430), to determine, estimate or infer the battery temperature, by identifying the reference EIS measurement output that most closely matches or corresponds to the EIS measurement result generated by the temperature estimation system 430.

Thus, the temperature estimation system 430 can estimate the temperature of the battery 410 without interrupting the operation of the electronic device 400 and without requiring an array of temperature sensors.

The circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system for controlling charging of a battery, the system comprising:
charging circuitry for supplying a charging current or voltage to the battery,
wherein the charging circuitry is configured to periodically detect an impedance of the battery and to control the charging current or voltage based on the detected impedance.

2. The system of claim 1, further comprising a heating arrangement for heating the battery, wherein the charging circuitry is configured to control the heating arrangement based on the detected impedance of the battery to maintain a temperature of the battery within a predefined range for charging.

3. The system of claim 1, wherein the charging circuitry is configured to detect a voltage and a current of the battery and to detect the impedance based on the detected voltage and current.

4. The system of claim 1, wherein the charging circuitry is configured to infer a temperature of the battery based on the detected impedance.

5. The system of claim 4, further comprising a heating arrangement for heating the battery, wherein the charging circuitry is configured to control the heating arrangement based on the inferred temperature of the battery.

6. The system of claim 5, wherein the charging circuitry is configured to control the heating arrangement based on the inferred temperature of the battery and one of more of:
a state of charge (SoC) of the battery;
a state of health (SoH) of the battery.

7. The system of claim 4, wherein the charging circuitry is configured to control the charging current supplied to the battery based on the inferred temperature of the battery.

8. The system of claim 7, wherein the charging circuitry is configured to control the charging current supplied to the battery based on the inferred temperature of the battery and one or more of:
a state of charge (SoC) of the battery;
a state of health (SoH) of the battery.

9. The system of claim 4, wherein the charging circuitry is configured to detect the impedance of the battery across a plurality of different frequencies or frequency ranges, and to infer the temperature of the battery based on the detected impedance across the plurality of different frequencies or frequency ranges.

10. The system of claim 9, wherein the charging circuitry is configured to monitor a load current drawn from the battery and to detect the impedance of the battery across the plurality of different frequencies or frequency ranges based on the monitored load current to generate an electrochemical impedance spectrum (EIS) measurement output for the battery.

11. The system of claim 10, wherein the charging circuitry is configured to control a current consuming device to draw additional current from the battery if the frequency content of the monitored load current is insufficient to detect the impedance of the battery across a minimum number of different frequencies or frequency ranges.

12. The system of claim 11, wherein the charging circuitry is configured to determine a quality metric for the load current based on a spectral content and amplitude of the load current, and to control the current consuming device to draw the additional current from the battery if the quality metric is below a predefined threshold.

13. The system of claim 10, wherein the charging circuitry is configured to compare the EIS measurement output generated by the charging circuitry for the battery to a set of reference EIS measurement outputs to infer the temperature of the battery.

14. The system of claim 1, wherein the system is configured to:
receive a temperature measurement of a host device incorporating the system when the host device is inactive or in a sleep or idle mode of operation;
detect the impedance of the battery when the host device is inactive or in the sleep or idle mode of operation; and
calibrate the system using the received temperature measurement and the detected impedance when the host device is inactive or in the sleep or idle mode of operation.

15. The system of claim 2, wherein the heating arrangement comprises a coil for inductive power transfer between a host device incorporating the system and another device.

16. The system of claim 2, wherein the heating arrangement comprises an array of resistive elements disposed, in use of the system, in proximity to the battery.

17. The system of claim 2, wherein the heating arrangement comprises circuitry configured to supply a signal or waveform to the battery to cause a change in a temperature of the battery by changing resistive losses in the battery.

18. The system of claim 17, wherein the circuitry is configured to supply a time varying current or voltage signal to the battery.

19. The system of claim 2, wherein the charging circuitry operable, when the system is connected to a power source external to the system, to:
detect the impedance of the battery;
determine a temperature of the battery based on the detected impedance; and
if the determined temperature of the battery is below a predetermined battery temperature range, output a heating control signal to cause the heating arrangement to heat the battery.

20. The system of claim 19, wherein the charging circuitry is further operable to delay charging of the battery until the temperature of the battery has reached the predetermined battery temperature range.

21. A system for controlling charging of a battery, the system comprising:
a charging circuit configured to:
detect an impedance of the battery;
infer, based on the detected impedance of the battery, a temperature of the battery;
supply a charging current to the battery, wherein the charging current is based on the inferred temperature of the battery.

22. A system for controlling charging of a battery, the system comprising:
a heating arrangement for heating the battery;
a charging circuit configured to detect a temperature of the battery and to control the heating arrangement based on the detected temperature to maintain an impedance of the battery within a predefined impedance range for charging.

23. A system for estimating a temperature of a battery, wherein the system is configured to:
monitor a load current drawn from the battery;
based on the monitored load current, detect the impedance of the battery across a plurality of different frequencies or frequency ranges to generate an electrochemical impedance spectrum (EIS) measurement output for the battery; and
estimate the temperature of the battery based on the EIS measurement output.

24. The system of claim 23, wherein the system is further configured to receive a battery state of charge (SoC) and/or state of health (SoH) and to estimate the temperature of the battery based on a combination of the EIS measurement output and the SoC and/or SoH.

25. The system of claim 24, wherein the system is configured to compare the EIS measurement output to a set of reference EIS measurement outputs to infer the temperature of the battery.

26. The system of claim 24, wherein the system is further configured to:
receive a battery state of charge (SoC) and/or state of health (SoH);
select at least one reference EIS measurement output based on the received SoC and/or SoH; and
estimate the temperature of the battery based on the selected at least one reference EIS measurement output and the EIS measurement output generated by the system.

27. The system of claim 24, wherein the system is configured to control a current consuming device to draw additional current from the battery if a frequency content of the monitored load current is insufficient to detect the impedance of the battery across a minimum number of different frequencies or frequency ranges.

28. The system of claim 27, wherein the system is configured to determine a quality metric for the load current based on the spectral content and amplitude of the load current, and to control the current consuming device to draw the additional current from the battery if the quality metric is below a predefined threshold.

29. The system of claim 23, wherein the system is configured to:
receive a temperature measurement of a host device incorporating the system when the host device is inactive or in a sleep or idle mode of operation;
detect the impedance of the battery when the host device is inactive or in the sleep or idle mode of operation; and
calibrate the system using the received temperature measurement and the detected impedance when the host device is inactive or in the sleep or idle mode of operation.

30. A system for controlling charging of a battery, the system comprising:
charging circuitry for supplying a charging current to the battery; and
a heating arrangement for heating the battery,
wherein the charging circuitry is configured to detect an impedance of the battery and to control the heating arrangement based on the detected impedance to maintain a temperature of the battery within a predefined temperature range for charging.

31. An integrated circuit comprising a system according to claim 1.

32. A host device comprising a system according to claim 1.

33. A host device according to claim 32, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.
